(19) United States
(12) Patent Application Publication
(10) Pub. No.: US 2019/0180636 A1
(43) Pub. Date: Jun. 13, 2019

(54) COMPREHENSION-LEVEL CALCULATION DEVICE AND COMPREHENSION-LEVEL CALCULATION METHOD

(71) Applicant: Hitachi, Ltd., Chiyoda-ku, Tokyo (JP)

(72) Inventors: Miaomei LEI, Tokyo (JP); Toshinori MIYOSHI, Tokyo (JP); Yoshiki NIWA, Tokyo (JP); Hiroki SATO, Tokyo (JP)

(21) Appl. No.: 16/328,667

(22) PCT Filed: Feb. 23, 2017
(86) PCT No.: PCT/JP2017/006834

§ 371 Date: Feb. 26, 2019

(30) Foreign Application Priority Data
Sep. 2, 2016 (JP) 2016-171732

(51) Int. Cl. G09B 5/00; G09B 19/00

(52) U.S. Cl. CPC G09B 5/00; G09B 19/00

(57) ABSTRACT

A comprehension-level calculation device that calculates a comprehension level of a user to sound language, retains respective time series of pieces of biological information in a plurality of regions of the user during presentation of the sound language to the user, calculates a similarity level for each pair of the time series, calculates the comprehension level on the basis of the calculated similarity level, and determines, in a case where the calculated similarity level is higher, the comprehension level as a higher value in the calculation of the comprehension level.

### CROSS-REFERENCE TO RELATED APPLICATION

This application is based on and claims the benefit of priority from Japanese Patent Application No. 2016-171732 filed on Sep. 2, 2016, the contents of which are incorporated herein by reference.

### TECHNICAL FIELD

The present invention relates to a comprehension-level calculation device and a comprehension-level calculation method.

### BACKGROUND ART

In recent years, as brain-visualization technology has been developed, not only physiological knowledge of a brain has broadened but also estimation of the state of a human from a brain measured signal has been performed. Examples of a method of measuring brain activity noninvasively include brain-wave measurement (electroencephalogram), functional magnetic resonance imaging (fMRI), magnetoencephalography, and near-infrared spectroscopy (NIRS).

As the background art of the present technical field, JP 2004-170958 A (PTL 1) is disclosed. PTL 1 states that “there is provided a learning-level measurement device 4 including: a measurement unit 1 that measures at least one of the volume of blood and the volume of a blood component in a predetermined measurement region S of the brain of a subject P; a time-varying data generation unit 2 that acquires, on a time-series basis, the at least one of the volume of blood and the volume of a blood component measured by the measurement unit 1 and generates time-varying data that is data indicating the variation in time of the at least one of the volume of blood and the volume of the blood component; and a waveform output unit 3 that outputs, in a case where, for determination of the learning level of the subject P to a task, the subject P has iteratively carried out a predetermined task a plurality of times, the waveform of time-varying data during each task, comparably” (refer to Abstract).

### CITATION LIST

### Patent Literature

PTL 1: JP 2004-170958 A

### SUMMARY OF INVENTION

### Technical Problem

According to the technology described in PTL 1, the comprehension level of a user to a task is calculated from the waveform of time-varying data of at least one of the volume of blood and the volume of a blood component in the predetermined measurement region. However, when a subject attempts to comprehend a task, because a plurality of regions in the user (e.g., a plurality of regions in the brain) works together, a comprehension level cannot necessarily be calculated accurately from a variation in the waveform of biological information in one region. Thus, an object of one aspect of the present invention is to calculate the comprehension level of a user to sound language with high accuracy.

### Solution to Problem

In order to solve the problem, one aspect of the present invention adopts the following configuration. A comprehension-level calculation device configured to calculate a comprehension level of a user to sound language, includes: a processor; and a storage device, in which the storage device retains respective time series of pieces of biological information in a plurality of regions of the user during presentation of the sound language to the user, and the processor: calculates a time-series similarity level for each pair of the time series; calculates the comprehension level, based on the calculated similarity level; and determines, in a case where the calculated similarity level is higher, the comprehension level as a higher value in the calculation of the comprehension level.

### Advantageous Effects of Invention

According to the one aspect of the present invention, the comprehension level of the user to the sound language can be calculated with high accuracy.

Problems, configurations, and effects other than the above will be clear in the descriptions of the following embodiments.

### BRIEF DESCRIPTION OF DRAWINGS

FIG. 1A is a block diagram of an exemplary configuration of a dialogue system according to a first embodiment.

FIG. 1B illustrates exemplary text data according to the first embodiment.

FIG. 1C illustrates exemplary sound data according to the first embodiment.

FIG. 1D illustrates exemplary image data according to the first embodiment.

FIG. 2 is a flowchart of exemplary information presentation processing according to the first embodiment.

FIG. 3 illustrates an exemplary content selection screen according to the first embodiment.

FIG. 4 illustrates an exemplary content presentation method according to the first embodiment.

FIG. 5 illustrates exemplary hemoglobin concentration data according to the first embodiment.

FIG. 6 is an explanatory diagram of exemplary measurement channels according to the first embodiment.

FIG. 7 is a flowchart of exemplary in-brain connection calculation processing according to the first embodiment.

FIG. 8 illustrates exemplary average waveforms according to the first embodiment.

FIG. 9 illustrates an exemplary selection screen of connection-result output according to the first embodiment.

FIG. 10 illustrates an exemplary connection map according to the first embodiment.

FIG. 11 illustrates an exemplary connection network according to the first embodiment.

FIG. 12 illustrates an exemplary time-series connection map according to the first embodiment.

FIG. 13 is a flowchart of exemplary comprehension-level determination processing according to the first embodiment.

FIG. 14 illustrates an exemplary comprehension-level determination result according to the first embodiment.

FIG. 15 is a block diagram of an exemplary configuration of a dialogue system according to a second embodiment.

FIG. 16 is a flowchart of exemplary presentation-information control processing according to the second embodiment.

FIG. 17 illustrates an exemplary information-presentation-method selection screen according to the second embodiment.

### DESCRIPTION OF EMBODIMENTS

Embodiments of the present invention will be described below with reference to the accompanying drawings. It should be noted that the present embodiments are just exemplifications for achieving the present invention and thus the technical scope of the present invention is not limited to these. Common configurations in the figures are denoted with the same reference signs.

In the present embodiments, a dialogue system that is an exemplary comprehension-level calculation system, will be described. The dialogue system presents sound language to a user and acquires time series of biological information regarding the user during the presentation of the sound language. The dialogue system calculates the respective similarity levels between the acquired time series of the biological information (in-brain connections), and then calculates the comprehension level of the user to the sound language, on the basis of the calculated similarity levels. This arrangement enables the dialogue system to calculate the comprehension level of the user to the sound language with high accuracy. Note that, unless otherwise specified below, the user means a person who is a subject for comprehension-level determination, from which biological information is to be measured by a biological-information measurement instrument 104, in the present embodiments.

### First Embodiment

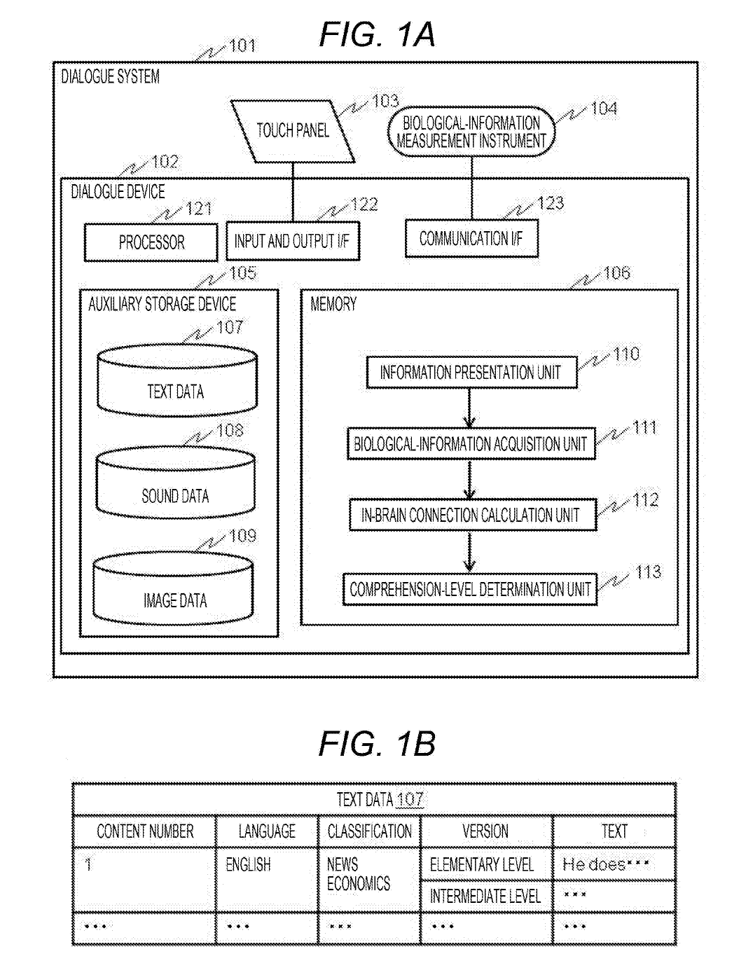

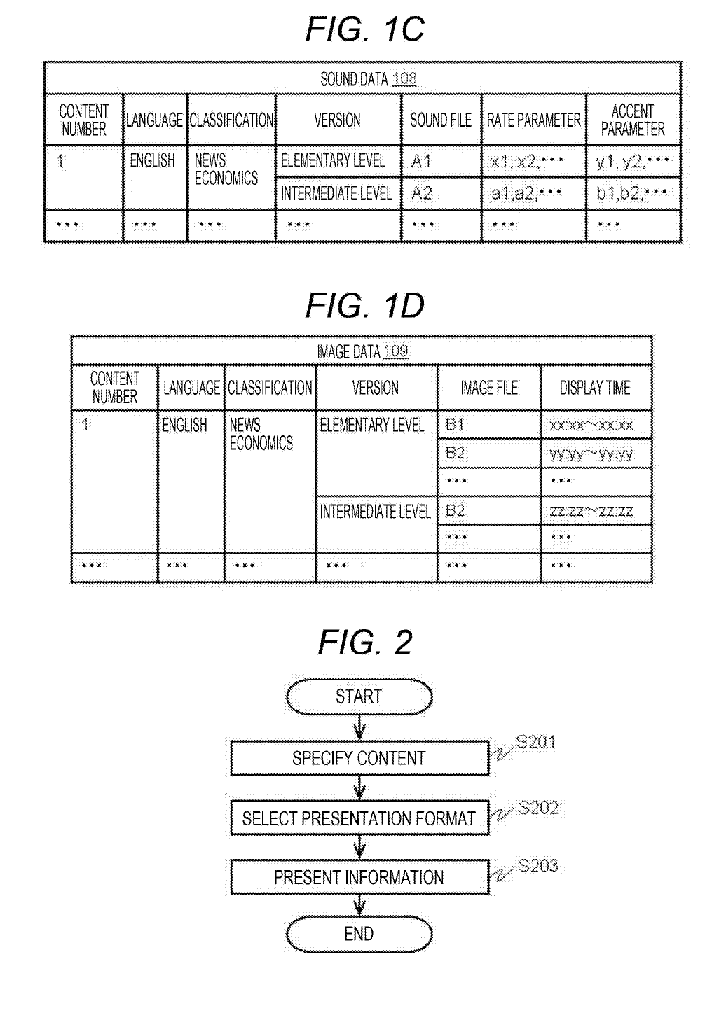

FIG. 1A is a block diagram of an exemplary configuration of a dialogue system. The dialogue system 101 includes, for example, a dialogue device 102, a touch panel 103, and a biological-information measurement instrument 104. The dialogue device 102 includes, for example, a calculator including: a processor (CPU) 121; an auxiliary storage device 105 and a memory 106 that each are a storage device; an input and output interface 122; and a communication interface 123. The dialogue device 102 is an exemplary comprehension-level calculation device.

The processor 121 executes a program stored in the memory 106. The memory 106 includes a ROM that is a nonvolatile memory and a RAM that is a volatile memory. The ROM stores, for example, an invariant program (e.g., a BIOS). The RAM is a high-speed and volatile memory, such as a dynamic random access memory (DRAM), and stores a program to be executed by the processor 121 and data to be used in the execution of the program, temporarily.

The auxiliary storage device 105 is a large-capacity and nonvolatile storage device, such as a magnetic storage device (hard disk drive: HDD) or a flash memory (solid state disk: SSD), and stores a program to be executed by the processor 121 and data to be used in the execution of the program. Note that part or all of the data stored in the auxiliary storage device 105 may be stored in the memory 106, and part or all of the data stored in the memory 106 may be stored in the auxiliary storage device 105.

The input and output interface 122 connected to, for example, the touch panel 103, receives an input from, for example, an operator and outputs an executed result of a program in a format visible to, for example, the operator. The touch panel 103 receives a character input or a sound input from a user, and outputs character information or sound information. An input device, such as a keyboard, a mouse, or a microphone, and an output device, such as a display device, a printer, or a speaker, may be connected to the input and output interface 122.

The communication interface 123 is a network interface device that controls communication with a different device in accordance with a predetermined protocol. The communication interface 123 includes a serial interface, such as USB. For example, the biological-information measurement instrument 104 is connected to the communication interface 123.

In the present embodiment, the biological-information measurement instrument 104 measures respective pieces of biological information in a plurality of brain regions of the user. Note that the biological-information measurement instrument 104 may measure biological information in a region other than the brain. An instrument that measures a variation in the volume of blood in a brain that is an exemplary brain function, with near-infrared spectrophotometry, is an example of the biological-information measurement instrument 104. The biological-information measurement instrument 104 may acquire brain-function information with a different measurement method, such as magnetic-field measurement. The biological-information measurement instrument 104 may be a camera or an eye-tracking system, and acquires, in that case, biological information, such as an expression or a visual line.

A program to be executed by the processor 121 may be provided to the dialogue device 102 through a removable medium (e.g., a CD-ROM or a flash memory) or through a network and may be stored in the nonvolatile auxiliary storage device 105 that is a non-transitory storage medium. Thus, it is desirable that the dialogue device 102 have an interface that reads data from the removable medium.

In a calculation system including one calculator physically or a plurality of calculators logically or physically, the dialogue device 102 may operate with separate threads on the same calculator or may operate on a virtual calculator constructed on the plurality of physical calculator resources.

For example, the auxiliary storage device 105 stores text data 107 retaining data in a text format of contents, sound data 108 retaining data in a sound format of the contents, and image data 109 retaining data in an image format of the contents. For example, the contents include: English proficiency examinations; English textbooks and reference books for primary schools, junior high schools, and senior high schools; and English news articles. The contents may be created in a language other than English.

The text data 107 retains a text corresponding to each content. Examples of the texts include English sentences and question sentences for listening questions in an English proficiency examination and English sentences in an English textbook or reference book.

The sound data 108 includes a sound corresponding to each content. For example, the sound data 108 includes a sound in which a text included in the text data 107 has been read aloud. For example, each sound included in the sound data is a synthetic sound having parameters capable of adjusting a rate and an accent, set.

The image data 109 includes an image corresponding to each content. For example, the image data 109 includes a supplementary image for comprehension of each English sentence included in the text data 107 and the sound data 108. For example, in a case where an English sentence of “He does his homework every day” is included in the text data 107 and the sound data 108, an image indicating a situation in which a body is doing his homework at a desk is an example of the images included in the image data 109. The dialogue device 102 may have a function of performing new addition, deletion, and editing to the text data 107, the sound data 108, and the image data 109 in accordance with an input from, for example, an administrator of the dialogue device 102.

The memory 106 includes an information presentation unit 110, a biological-information acquisition unit 111, an in-brain connection calculation unit 112, a comprehension-level determination unit 113, and an information control unit 114 that each are a program.

Execution of a program by the processor 121 performs determined processing with the storage device and a communication port (communication device). Therefore, a description in which a program is the subject, in the present embodiment, may be regarded as a description in which the processor 121 is the subject. Alternatively, processing to be performed with a program is processing to be performed by the calculator and the calculator system in which the program operates.

The processor 121 operates in accordance with a program, so as to operate as a functional unit (means) that achieves a predetermined function. For example, the processor 121 operates in accordance with the information presentation unit 110 that is a program, so as to function as an information presentation unit (information presentation means). A similar manner is made for the other programs. Furthermore, the processor 121 operates as respective functional units (means) that achieve a plurality of pieces of processing to be performed with each program. The calculator and the calculator system are a device and a system that include the functional units (means).

For example, the information presentation unit 110 outputs a content selected in accordance with an instruction from the user, as presentation information, to the touch panel 103. The information presentation unit 110 outputs at least one of the text in the text data 107, the sound in the sound data 108, and the image data 109 corresponding to the selected content.

The biological-information acquisition unit 111 acquires time series of the biological information in the plurality of brain regions of the user, measured by the biological-information measurement instrument 104 during comprehension activity of the user to the presentation information output by the information presentation unit 110. The biological-information acquisition unit 111 acquires respective signals indicating the biological information in the plurality of brain regions, the signals each being a one-channel signal.

The comprehension activity of the user means an activity in which the user comprehends the presentation information with any of the five senses. Examples of the comprehension activity of the user include user reading of the presentation information in the text format and user listening of the presentation information in the sound format. Note that the time series of the biological information according to the present embodiment have measured values of the biological information at not less than two points in time. Each of the time series of the biological information consists of, for example, a signal from each channel. A brain activity signal is an example of the biological information.

The in-brain connection calculation unit 112 calculates the similarity levels of the biological information between different channels (correlations). It is considered that a connection is strong between brain regions corresponding to channels between which the similarity level of the biological information is high (high correlation) and a connection is weak between brain regions corresponding to channels between which the similarity level of the biological information is low (correlation close to zero). It is considered that there is a mutual inhibition relationship between brain regions corresponding to channels having opposite variations (negative correlation) in the biological information (when one region works, the other is inhibited from working).

The in-brain connection calculation unit 112 calculates a connection map and a comprehension-level indicator, on the basis of the calculated similarity levels. The connection map and the comprehension-level indicator will be described later. The comprehension-level determination unit 113 determines the comprehension level of the user to the content, on the basis of the connection map and the comprehension-level indicator calculated by the in-brain connection calculation unit 112.

FIG. 1B illustrates an example of the text data 107. The text data 107 stores information indicating, for example, content number, content language, content classification, content version, and content text. The content number is information for identifying the contents. The content classification is information indicating an outline of the contents, and includes content formats, such as “textbooks”, “past exam questions”, and “news articles”, and topics in the contents, such as “economics” and “science”, or keywords in the contents.

The content version includes information indicating degrees of difficulty, such as “elementary level”, “intermediate level”, and “advanced level”. A content having different versions each having the same content number, has different texts, but the semantic contents of the content are the same.

FIG. 1C illustrates an example of the sound data 108. The sound data 108 stores information indicating, for example, content number, content language, content classification, content version, content sound file, sound rate parameter, and sound accent parameter. The sound file stores a sound in which a text having the same content number as that in the text data 107 has been read aloud. The rate parameter is intended for determining the sound rate of the sound file. The accent parameter is intended for determining the sound accent of the sound file.

FIG. 1D illustrates an example of the image data 109. The image data 109 stores, for example, content number, language, classification, version, image file, and display time. The image file stores a supplementary image for comprehension of a content having the same content number as those in the text data 107 and the sound data 108. The display time indicates, in a case where a content is reproduced, the start time and the end time of display of the corresponding image. Note that the display time may be variable in accordance with the sound rate parameter.

FIG. 2 is a flowchart of exemplary information presentation processing in the information presentation unit 110. The information presentation unit 110 specifies a content in accordance with an input from the user through the touch panel 103 (S201). Specifically, the information presentation unit 110 receives, for example, an input of a content classification and a version. The information presentation unit 110 specifies the content having the input classification and version.

Note that, in a case where a plurality of contents having the input classification is present, the information presentation unit 110 may randomly select one content from the plurality of contents. Alternatively, for example, the information presentation unit 110 may present respective texts and sounds corresponding to the plurality of contents, to the user and then may specify a content in accordance with an input of the user.

The information presentation unit 110 selects a presentation format for the content specified at step S201, in accordance with an input from the user through the touch panel 103 (S202). Examples of the presentation format for the content include a format of presenting a text and a sound, a format of presenting an image and a sound, and a format of presenting a text, a sound, and an image. Exemplary processing in a case where the information presentation unit 110 presents an image content and a sound content, will be described below in the present embodiment. Even in a case where the information presentation unit 110 presents a content in a different presentation format, processing similar to the processing to be described later, is performed.

Subsequently, the information presentation unit 110 selects the content specified at step S201 from the text data 107, the sound data 108, or the image data 109, in accordance with the presentation format selected at step S202, and then outputs the content to the touch panel 103 so as to present the content to the user (S203). Note that, at steps S201 and S202, for example, the information presentation unit 110 may randomly select a content and a presentation format instead of receiving an input from the user.

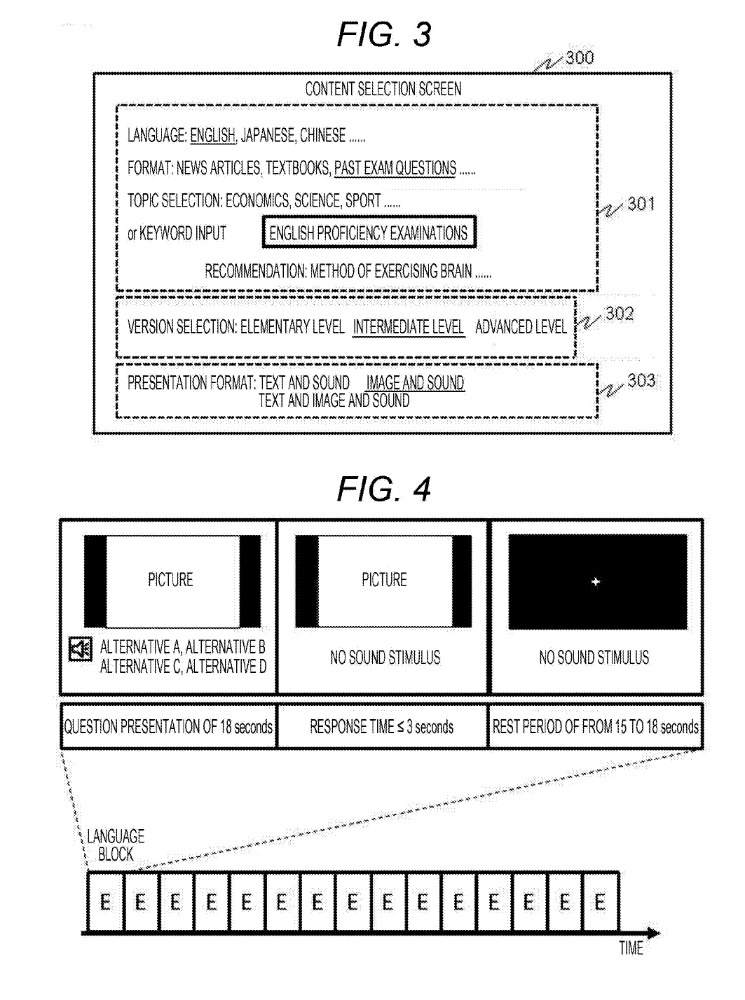

FIG. 3 illustrates an exemplary content selection screen that is a user interface for allowing the user to select a content. The content selection screen 300 includes, for example, a content-classification selection section 301, a version selection section 302, and a presentation-format selection section 303.

The content-classification selection section 301 is intended for receiving inputs of a content language and a content classification. In the example of FIG. 3, the user can select a content classification from “format” and “topic selection” in the content-classification selection section 301. The content-classification selection section 301 may receive an input of a keyword so as to receive a content classification. The information presentation unit 110 specifies, for example, a content having a classification designated in “format”, “topic selection”, or “keyword input” in the content-classification selection section 301, from the text data 107, the sound data 108, or the image data 109.

The version selection section 302 is intended for receiving an input of a version. In the example of FIG. 3, the user can select a version from the elementary level, the intermediate level, or the advance level. The presentation-format selection section 303 is intended for receiving an input of a presentation-format selection.

FIG. 3 illustrates the example in which a content having past exam questions and English proficiency examinations for the classification, English for the language, and the intermediate level for the version has been specified, and the sound of the specified content and the image of the specified content have been selected from the sound data 108 and the image data 109, respectively.

Note that, for example, information specifying a related content classification for each classification of the contents, may be stored in the auxiliary storage device 105. The information presentation unit 110 may display, into “recommendation” in the content-classification selection section 301, a related classification in the information to the classification of a content selected by the user in the past, as the classification of a content in which the user is likely to show an interest.

FIG. 4 illustrates an exemplary content presentation method according to the present embodiment. The example in which the content includes listening questions in an English proficiency examination and the presentation format includes the sound and the image, will be described in FIG. 4. In the example of FIG. 4, the dialogue system 101 presents the listening questions having 15 questions in the English proficiency examination, to the user. Each E in the figure indicates one language block.

In the example of FIG. 4, one listening question is presented in one language block. Each listening question consists of, for example, a question presentation period of 18 seconds, a response period of not more than 3 seconds, and a rest period of from 15 to 18 seconds. Note that the length of each of the periods is exemplary. The biological-information acquisition unit 111 acquires the biological information measured by the biological-information measurement instrument 104, as time series in each language block.

During the question presentation period, for example, one image is displayed and the sounds of in total four English sentences including one English sentence expressing the content of the image properly, are produced as alternatives. The user performs a comprehension activity to the question within the question presentation period of 18 seconds. In the example of FIG. 4, as the comprehension activity, the user considers which English sentence expresses the displayed image most properly from the four alternatives.

After completion of the question presentation period, the response period of not more than 3 seconds starts. During the response period, for example, the user selects an answer from the four alternatives through the touch panel 103. Note that, instead of the touch panel 103, for example, a keyboard for inputting an answer may be connected to the input and output interface 122.

After completion of the response period, the rest period starts. During the rest period, for example, the image displayed during the question presentation period and the response period, disappears and a cross is displayed at the center of the screen. Within the rest period, for example, the user views the cross at the center of the screen and becomes at rest. Comprehension-level calculation processing in a case where the content of FIG. 4 is presented to the user, will be described below in the present embodiment.

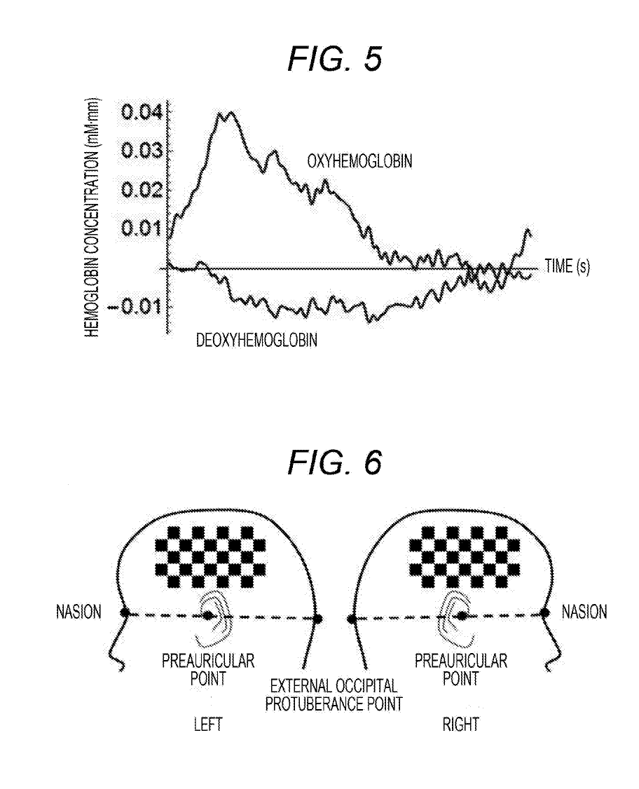

FIG. 5 illustrates exemplary hemoglobin concentration data. The hemoglobin concentration data is exemplary biological information to be acquired by the biological-information acquisition unit 111. The hemoglobin concentration data of FIG. 5 indicates time series of the oxyhemoglobin concentration and the deoxyhemoglobin concentration of the user who performs a comprehension activity.

In FIG. 5, a value that starts rising simultaneously with the measurement start is the value of the oxyhemoglobin concentration, and a value that starts falling from the measurement start is the value of the deoxyhemoglobin concentration. For example, the biological-information measurement instrument 104 measures time series of at least one of the oxyhemoglobin concentration and the deoxyhemoglobin concentration in blood in a plurality of measurement regions of the superficial layer of the brain of the user, with the near-infrared spectrophotometry. Note that, for example, a near-infrared measurement device that is an example of the biological-information measurement instrument 104, is used for the measurement of the hemoglobin concentration.

For example, the biological-information measurement instrument 104 may measure the hemoglobin concentration in the entire brain or may measure the hemoglobin concentration only in the language area in which language is comprehended or in the frontal lobe in which cognitive activities are performed. For example, the biological-information measurement instrument 104 irradiates a living body with near-infrared light. The emitted light that is incident on the living body is scattered and is absorbed in the living body, and then the biological-information measurement instrument 104 detects propagated and output light.

Note that, for example, the biological-information measurement instrument 104 acquires a variation in the flow of blood in the brain from an internal state when the user performs a comprehension activity, and then measures the hemoglobin concentration. The biological-information acquisition unit 111 acquires the hemoglobin concentration measured by the biological-information measurement instrument 104, the hemoglobin concentration being during the comprehension activity performed by the user.

FIG. 6 is an explanatory diagram of exemplary measurement channels according to the present embodiment. Black squares each indicate the position of a measurement channel. For example, the measurement channels are disposed on at least one straight line parallel to a straight line connecting a nasion, a preauricular point, and an external occipital protuberance point. A brain area to be measured according to the present embodiment, is the temporal lobe. The temporal lobe includes the auditory cortex and the language area including Broca's area and Wernicke's area. In FIG. 6, respective 22 measurement channels (44 channels in total) are disposed on the right and the left.

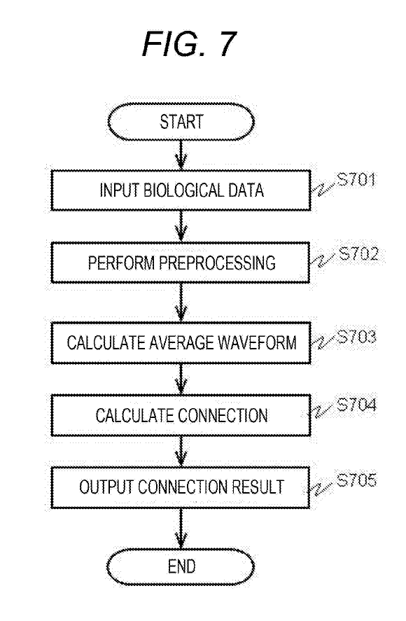

FIG. 7 is a flowchart of exemplary in-brain connection calculation processing. The in-brain connection calculation unit 112 acquires the time series of the biological information across the language blocks acquired by the biological-information acquisition unit 111. In the present embodiment, an example in which the biological information is hemoglobin concentration, will be described.

The near-infrared measurement device measures the hemoglobin concentration with a method of noninvasively measuring hemodynamics in the head with light. Therefore, because a signal acquired by the near-infrared measurement device includes a signal related to the brain activity and information related to the systemic hemodynamics, for example, due to a variation in heart rate, preprocessing for removing noise is required.

The in-brain connection calculation unit 112 performs the preprocessing (S702). The in-brain connection calculation unit 112 performs, for example, frequency band-pass filtering, polynomial baseline correction, main component analysis, and independent component analysis as the preprocessing.

Specifically, for example, the in-brain connection calculation unit 112 separates the signals for each language block. That is the in-brain connection calculation unit 112 separates the signals for periods consisting of the question presentation period, the response period, and the rest period. The in-brain connection calculation unit 112 performs noise removal and baseline correction to the signals of each language block after the separation.

Note that, for example, the respective correct answers for the questions may be stored in the text data 107. The in-brain connection calculation unit 112 may exclude the signals of a language block in which the answer selected by the user through the touch panel 103 is wrong, in reference to the correct answers.

The in-brain connection calculation unit 112 may use only an oxyhemoglobin signal, may use only a deoxyhemoglobin signal, or may use the sum total of the oxyhemoglobin signal and the deoxyhemoglobin signal (total hemoglobin signal), as a signal indicating a time series of the biological information.

Subsequently, the in-brain connection calculation unit 112 calculates, for example, the time series of the average of the hemoglobin signals of all the language blocks (15 language blocks in the example of FIG. 4) for each channel, as an average waveform (S703). Note that the in-brain connection calculation unit 112 calculates the average waveform, for example, with the following Formula (1).

$$\begin{matrix}[ Mathematical Formula 1 ] & \\ AVERAGE Hb ( t ) = \frac{{\sum }_{i = 1}^{n} Hb ( t , i )}{n} & ( 1 )\end{matrix}$$

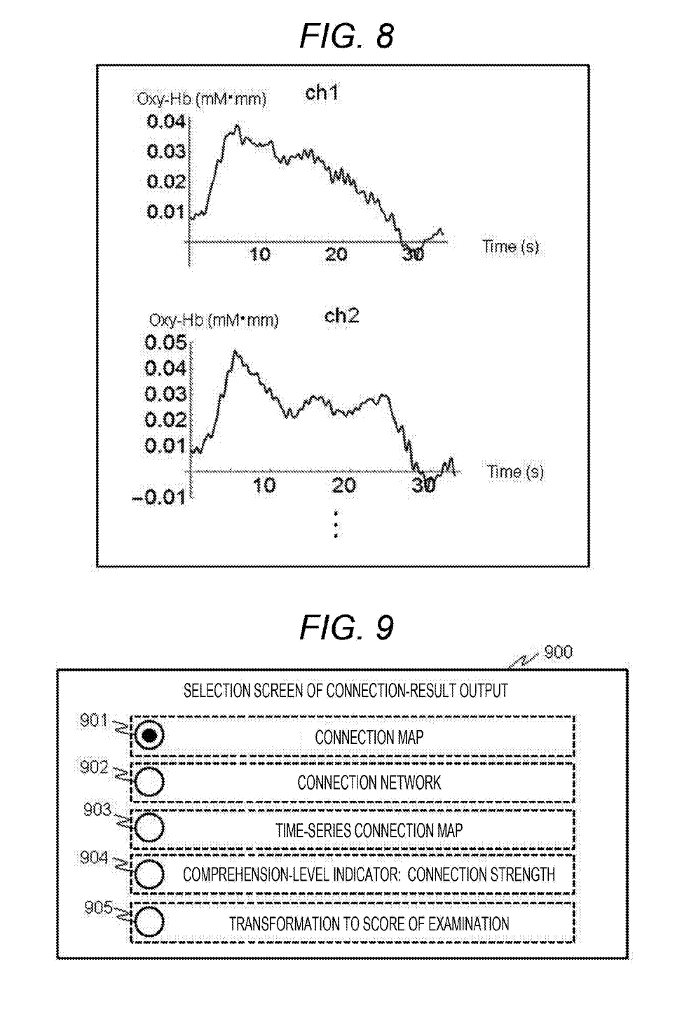

Time in a language block is represented by t. In the present embodiment, the defined range of t satisfies 0≤t≤T (T represents the length in time of one language block). In the example of FIG. 4, because the question presentation period is 18 seconds, the response period is not more than 3 seconds, and the rest period ranges from 15 to 18 seconds, T has a value of from 33 to 39 seconds. Note that, the example in which the respective lengths in time of all the language blocks are the same, has been described in the present embodiment. The total number of language blocks is represented by n, and n is 15 in the example of FIG. 4. FIG. 8 illustrates an exemplary average waveform of each channel.

Subsequently, the in-brain connection calculation unit 112 calculates the similarity levels of the time-series average signals between the plurality of channels (average waveforms of the hemoglobin signals according to the present embodiment) as connections between the brain areas (S704). In the present embodiment, at step S704, the in-brain connection calculation unit 112 calculates the respective similarity levels of the pairs of the channels (consisting of the pairs of the same channels). The in-brain connection calculation unit 112 calculates the similarity level of the time-series average signals between two channels, for example, with the following Formula (2).

$$\begin{matrix}[ Mathematical Formula 2 ] & \\ SIMILARITY LEVEL ( X , Y ) = \frac{{\sum }_{t = 0}^{T} ( {x}_{t} - \overline{x} ) ( {y}_{t} - \overline{y} )}{\sqrt{( {\sum }_{t = 0}^{T} {( {x}_{t} - \overline{x} )}^{2} ) ( {\sum }_{t = 0}^{T} {( {y}_{t} - \overline{y} )}^{2} )}} & ( 2 )\end{matrix}$$

Here, X and Y represent the time-series average waveform of a channel x and the time-series average waveform of a channel y, respectively (Hb(t) in the present embodiment). xₜ and yₜ represent a value at time t in the time series of the channel x and a value at time t in the time series of the channel y, respectively. x with an overbar and y with an overbar represent the average value in time of the time series of the channel x and the average value in time of the time series of the channel y, respectively.

Note that the average value in time of a time series is defined, for example, with the average value of values at predetermined times in the time series. For example, for calculation for Σ in Formula (2), the in-brain connection calculation unit 112 calculates the sum of values at the predetermined times in t=0 to T (T represents the length in time of one language block) in each Σ.

Note that, for example, the in-brain connection calculation unit 112 may calculate the absolute value of the integral of the difference between the time-series average signals of two channels as the similarity level between the two channels. Although calculating the similarity level for the average waveforms of the hemoglobin signals, the in-brain connection calculation unit 112 may, instead of calculating the average waveforms, calculate the similarity levels of the hemoglobin signals for each language block, to calculate a comprehension level to be described later, for each language block.

In the example of FIG. 6, because the 44 channels in total are provided on the right and the left, the in-brain connection calculation unit 112 calculates 44×44 similarity levels (correlation coefficients) and determines a 44 by 44 correlation matrix having the calculated similarity levels as elements.

Note that, because the time-series average waveforms X and Y of arbitrary channels satisfy the similarity level (X, Y)=the similarity level (Y, X), the in-brain connection calculation unit 112 may calculate only one of the similarity level (X, Y) and the similarity level (Y, X) in the determination of the correlation matrix. Because the time-series average waveform X of an arbitrary channel satisfies the similarity level (X, X)=1, instead of using Formula (2) in calculation for the diagonal components of the correlation matrix, the values of all the diagonal components may be determined as 1.

Subsequently, the in-brain connection calculation unit 112 outputs a connection result based on a result of the calculation at step S704 (S705).

FIG. 9 illustrates an exemplary selection screen of connection-result output. The selection screen 900 includes, for example, radio buttons 901 to 904 for outputting the connection result. The radio buttons 901 to 905 are intended for outputting a connection map, a connection network, a time-series connection map, a comprehension-level indicator, and a result transformed in an exam score that are exemplary connection results.

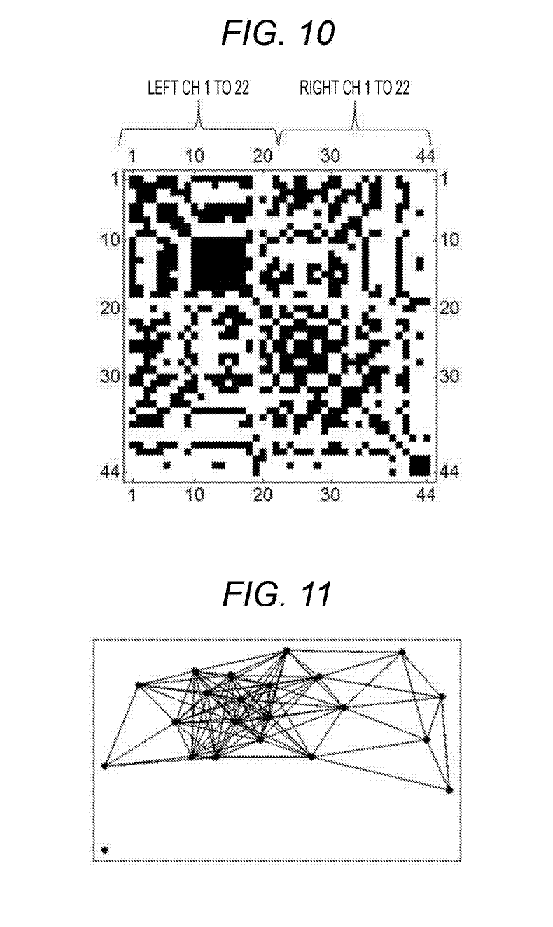

FIG. 10 illustrates an exemplary connection map. The connection map is a heat map in which the correlation matrix calculated at step S704 is visualized. Numbers in the figure are respective identifiers of the channels. Identifiers 1 to 22 in the figure are the identifiers of the 22 channels that measure the left brain of the user (namely, disposed at the left head), and identifiers 23 to 44 are the identifiers of the 22 channels that measure the right brain of the user (namely, disposed at the right head). In a case where the similarity level between two channels is a predetermined value or more, a part corresponding to the two channels is filled in black in the connection map. In a case where the similarity level between two channels is less than the predetermined value, a cell corresponding to the two channels is filled in white in the connection map.

The user can determine the presence or absence of the connections between the channels in reference to the connection map. Note that the example of the connection map of FIG. 10 expresses the similarity level between two channels only in binary with black and white with the predetermined value as a criterion. However, for example, whether the similarity level is high or low may be expressed in shades of color with a plurality of threshold values as criteria.

In the example of FIG. 10, the upper-left 22×22 cells in the connection map express the in-brain connections between the 22 channels of the left brain, and the lower-right 22×22 cells express the in-brain connections between the 22 channels of the right brain. The upper-right 22×22 cells and the lower-left 22×22 cells in the connection map each express the in brain connections between the 22 channels of the left brain and between the 22 channels of the right brain. Note that a similarity-level matrix corresponding to the upper-right 22×22 cells is the symmetric matrix of the lower-left 22×22 similarity-level matrix.

FIG. 11 illustrates an exemplary connection network. For example, the connection network is a graph in which each channel is a node and channels between which the similarity level is a predetermined value or more (e.g., 0.7) are connected through an edge. The in-brain connection calculation unit 112 creates the connection network, for example, with a force-directed algorithm. Note that an edge indicating autocorrelation (namely, the similarity level between the same channels) is not displayed in the connection network.

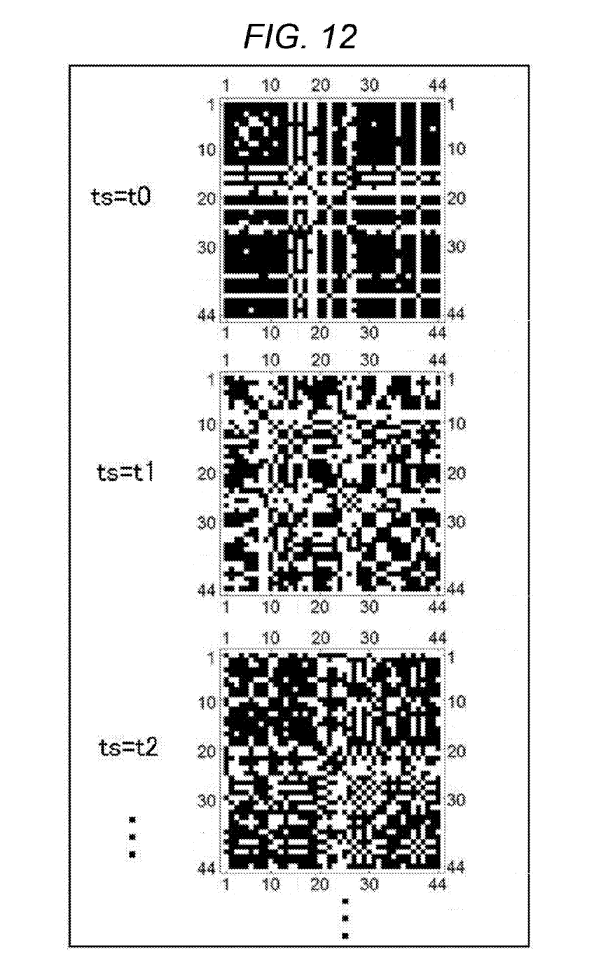

FIG. 12 illustrates an exemplary time-series connection map. The time-series connection map displays, on a time-series basis, connection maps corresponding to the similarity levels at a plurality of times that each is a criterial time.

An exemplary method of creating the time-series connection map, will be described below. For example, at step S704, the in-brain connection calculation unit 112 creates a connection map corresponding to the criterial time tₛ (0≤tₛ≤T). Specifically, a connection map corresponding to the criterial time tₛ is created with a mathematical formula in which the range of Σ in Formula (2) above is from tₛ−k (from 0 for tₛ−k<0) to tₛ+k (to T for tₛ+k>T) (k represents a positive constant and is, for example, 5).

The in-brain connection calculation unit 112 creates connection maps corresponding to the plurality of criterial times with the method, and outputs, for example, the connection maps in series in earlier order of the plurality of criterial times. FIG. 12 illustrates the time-series connection map for the criterial time tₛ=t₀, t₁, t₂, . . . .

The in-brain connection calculation unit 112 outputs the connection map, the connection network, or the time-series connection map, so that the administrator and the user can grasp a plurality of relationships in the biological information, easily. The in-brain connection calculation unit 112 outputs the time-series connection map, so that the administrator and the user can grasp a variation in time between the plurality of relationships in the biological information, easily.

A comprehension-level indicator will be described below. The comprehension-level indicator is an exemplary comprehension level of the user to the presented content. The in-brain connection calculation unit 112 calculates the comprehension-level indicator, for example, with the connection map or the connection network.

An exemplary method of calculating the comprehension-level indicator with the connection map, will be described. For example, the comprehension-level determination unit 113 calculates the average value of similarity levels for each channel. For example, the comprehension-level determination unit 113 calculates a weighting sum of the calculated average value with a previously determined weight for each channel, as the comprehension-level indicator.

Note that it is desirable that the weight to each channel be determined on the basis of the anatomical function of a measurement region corresponding to each channel. For example, because it is considered that the auditory sense that processes sound is not important when the user comprehends a foreign language, it is desirable that the weight to a measurement channel for the auditory cortex have a small value. Because it is considered that Wernicke's area is an important brain region when sound language is comprehended, it is desirable that the weight to a channel corresponding to Wernicke's area have a large value.

For example, in a case where the number of channels is large for measurement of one region in the brain (e.g., the frontal lobe), the comprehension-level determination unit 113 may integrate and handle the channels as one channel and may calculate the average value of similarity levels. Specifically, for example, the comprehension-level determination unit 113 may randomly select one channel from the channels and may calculate the average value of similarity levels of the selected channel, or may calculate the average value of all similarity levels corresponding to the channels. Note that, in this case, for example, a weight is determined to the integrated one channel.

An exemplary method of calculating the comprehension-level indicator with the connection network, will be described below. For example, a weight is previously determined to each channel. As described above, it is desirable that the weight be determined on the basis of the anatomical function of a measurement region corresponding to each channel. For example, the comprehension-level determination unit 113 calculates, with the weights described above, a weighting sum of the number of edges generated from each of the nodes indicating the channels on the connection network, as a comprehension level. That is, for each channel, the weighting sum is a weighting sum of the number of similarity levels having the predetermined value or more from the similarity levels corresponding to the channel.

For example, the comprehension-level determination unit 113 may calculate a weighting sum with predetermined weights for the distances on the connection network between the respective nodes indicating the channels, as the comprehension-level indicator. Note that the predetermined weights are previously determined, for example, to all pairs of the channels.

When the radio button 905 of FIG. 9 is selected, for example, the comprehension-level determination unit 113 substitutes the correlation matrix calculated at step S704 or the comprehension-level indicator calculated from the correlation matrix, into a previously determined transformation equation, and calculates the score of the English proficiency examination of FIG. 4. The transformation equation is previously determined, for example, in accordance with compared results between previously prepared samples for the correlation matrix or the comprehension-level indicator and samples of actual scores of the English proficiency examination when a plurality of humans (e.g., 100 people) takes the examination.

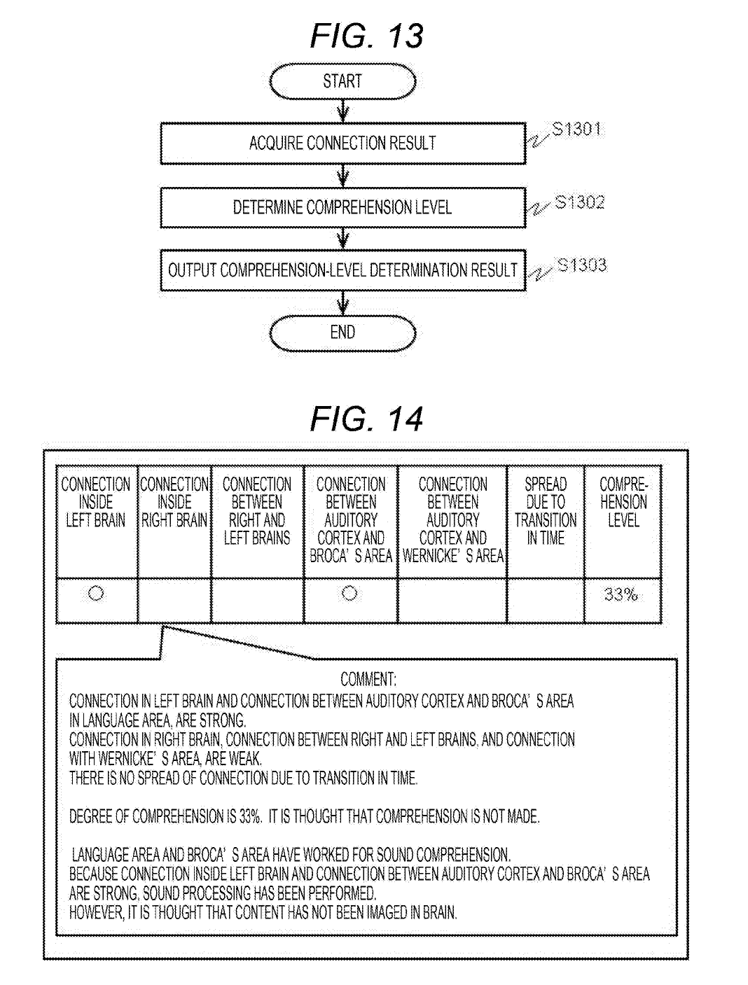

FIG. 13 is a flowchart of an exemplary outline of comprehension-level determination processing. The comprehension-level determination unit 113 performs comprehension-level determination, on the basis of the connection result calculated by the in-brain connection calculation unit 112 (e.g., the correlation matrix, the connection map, the connection network, or the comprehension-level indicator).

First, the comprehension-level determination unit 113 acquires the connection result calculated by the in-brain connection calculation unit 112 (S1301). Subsequently, the comprehension-level determination unit 113 performs the comprehension-level determination of the user, on the basis of the acquired connection result (S1302). The details of step S1302 will be described later. The comprehension-level determination unit 113 outputs a comprehension-level determination result, for example, through the touch panel 103 (S1303).

FIG. 14 illustrates an exemplary comprehension-level determination result. For example, it is considered that sound language is comprehended more deeply as the connection inside the left brain, the connection inside the right brain, the connection between the right and left brains, the connection between the auditory cortex and Broca's area, and the connection between the auditory cortex and Wernicke's area each get stronger.

In the example of FIG. 14, information indicating whether the connections are strong, is displayed. Note that, for example, the comprehension-level determination unit 113 determines whether the connection inside the left brain is strong, on the basis of the similarity level between channels that measure the left brain.

Specifically, for example, at step S1302, the comprehension-level determination unit 113 determines that the connection inside the left brain is strong, in a case where the similarity level between predetermined channels that measure the left brain is a predetermined threshold value or more, and determines that the connection inside the left brain is weak, in a case where the similarity level is less than the predetermined threshold value. For example, the comprehension-level determination unit 113 determines whether the connection inside the right brain is strong, with a similar method.

For example, at step S1302, the comprehension-level determination unit 113 determines that the connection between the right and left brains is strong, in a case where the similarity level between a predetermined channel that measures the left brain and a predetermined channel that measures the right brain is a predetermined threshold value or more, and determines that the connection between the right and left brain is weak, in a case where the similarity level is less than the predetermined threshold value. For example, the comprehension-level determination unit 113 determines whether the connection between the auditory cortex and Broca's area is strong and whether the connection between the auditory cortex and Wernicke's area is strong, with similar methods.

It is considered that the comprehension level is high in a case where the connection regarding the auditory cortex is strong at the initial stage at which language stimulus is given to the user and then the connection regarding the right brain spreads. Although there are various methods of determining whether such spread is present, for example, the comprehension-level determination unit 113 performs Fisher's Z-transformation to the similarity levels regarding the right brain or the similarity levels regarding the auditory cortex, to calculate Z-scores, and then determines that the spread is present in a case where the sum total gradually increases. Specifically, first, the comprehension-level determination unit 113 determines, for example, two points in time to be compared, and compares the difference of the Z-scores between the two points in time. Note that the plurality of points in time may be set by the user.

In the example of FIG. 12, the point in time t₀ indicates before the start of the comprehension activity, the point in time t₁ indicates a predetermined time past from the start of the comprehension activity (in the comprehension activity), and the point in time t₂ indicates the end of the comprehension activity. The comprehension activity has not started yet at the point in time t₀ in the example of FIG. 12 and thus the brain is not in activation. Therefore, it is desirable that setting the point in time at which the comprehension activity has not started, for a point in time to be compared, be avoided. In consideration of the delay from presentation of a task to a change of the brain activity, for example, in a case where the difference between the sum total of the Z-scores at the point in time t₁ at the predetermined time past from the start of the comprehension activity and the sum total of the Z-scores at the time t₂ at the end of the comprehension activity, exceeds a predetermined threshold value, the comprehension-level determination unit 113 determines that the spread is present.

FIG. 14 illustrates the example in which the comprehension-level determination unit 113 determines that “the connection inside the left brain” and “the connection between the auditory cortex and Broca's area” are strong, determines that “the connection inside the right brain”, “the connection between the right and left brains”, and “the connection between the auditory cortex and Wernicke's area” are not strong, and determines that “the spread due to a transition in time” is not present. The comprehension level in FIG. 14 is defined by the ratio of cells in which “∘” is described, in six cells in total consisting of five cells each indicating the presence or absence of connection in strength and one cell indicating the presence or absence of spread due to a transition in time.

The comment in FIG. 14 is a previously determined comment selected and output by the comprehension-level determination unit 113, for example, in accordance with the cells in which “∘” is described and the value of the comprehension level.

As described above, the dialogue system 101 according to the present embodiment can objectively provide the comprehension level of the user with the biological information in the comprehension activity of the user, and thus can prevent the user from intentionally concealing a comprehension level. The dialogue system 101 can visualize a more detailed comprehension level and a process of comprehension, instead of simple binary determination of whether or not the user comprehends a content.

The dialogue system 101 according to the present embodiment, can calculate a comprehension level from time series of the biological information while a content is being presented to the user once. That is, because the user is not required to listen to or read a content, iteratively, and thus the burden of the user can be reduced.

### Second Embodiment

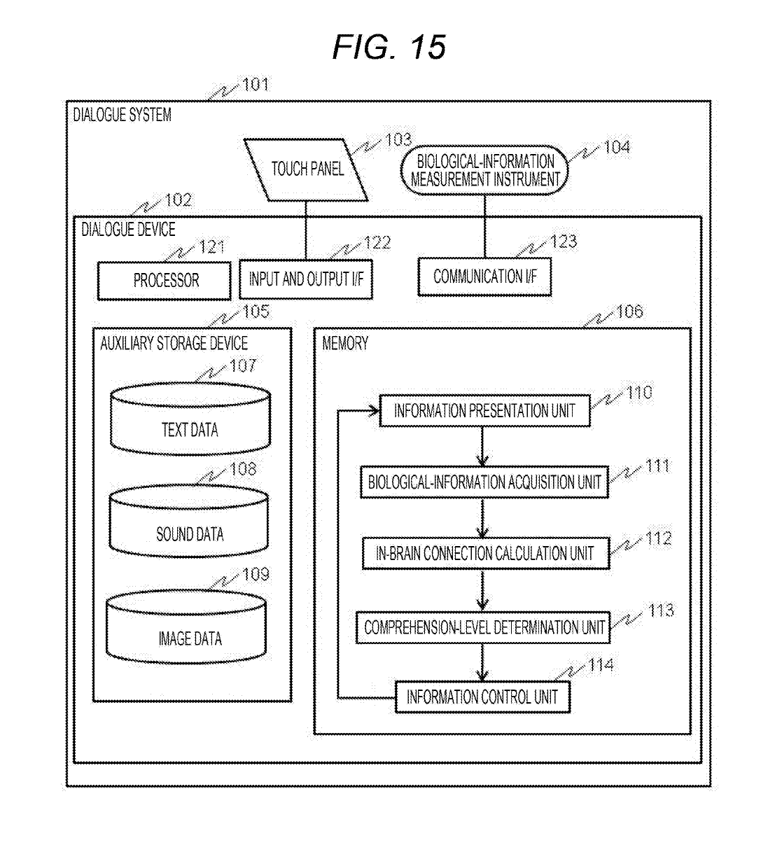

FIG. 15 is a block diagram of an exemplary configuration of a dialogue system 101 according to the present embodiment. A memory 106 of a dialogue device 102 according to the present embodiment, further includes an information control unit 114 that is a program. The other configurations in the dialogue system 101 are similar to those in the first embodiment, and thus the descriptions thereof will be omitted. The information control unit 114 controls information to be next presented to a user, on the basis of a comprehension level determined by a comprehension-level determination unit 113.

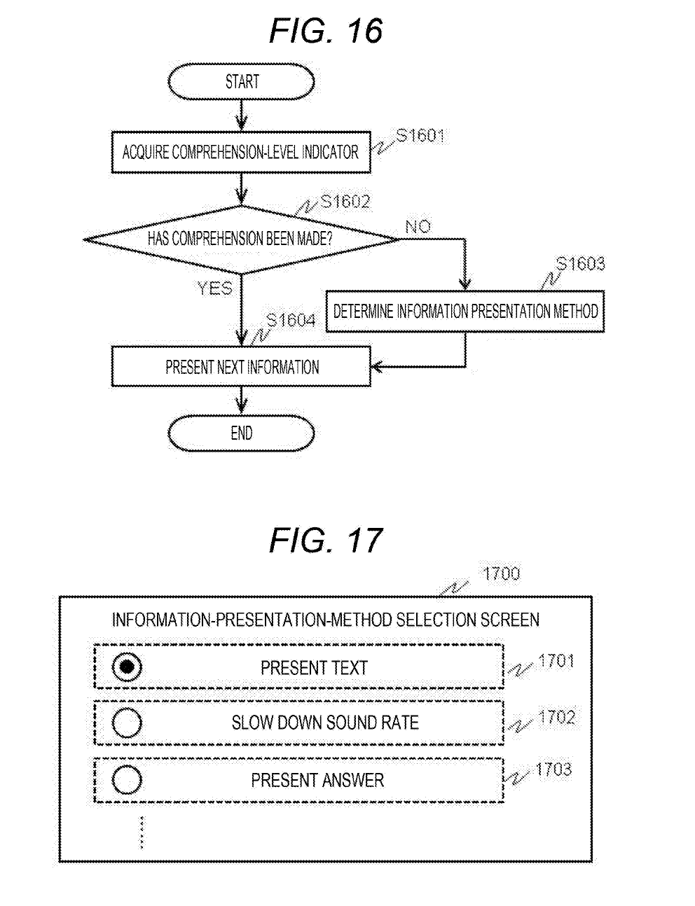

FIG. 16 illustrates exemplary presentation-information control processing by the information control unit 114. The information control unit 114 acquires a comprehension-level result including the comprehension level determined by the comprehension-level determination unit 113 (S1601). The information control unit 114 determines whether the user has comprehended the content, in accordance with the acquired comprehension level (S1602). At step 51602, for example, the information control unit 114 determines that the user has comprehended the content, in a case where the acquired comprehension level is a predetermined value or more, and determines that the user has not comprehended the content, in a case where the acquired comprehension level is less than the predetermined value. Note that, at step S1602, a comprehension-level indicator may be used instead of the comprehension level or in addition to the comprehension level.

In a case where determining that the user has not comprehended the content (S1602: NO), the information control unit 114 determines information to be presented in accordance with the comprehension-level result (S1603) and presents the next information (S1604). For the passage of step S1603, for example, the information control unit 114 presents a content in which the degree of difficulty of the presented content is lowered. In a case where determining that the user has comprehended the content (S1602: YES), the information control unit 114 presents the next information, such as a different content (S1604).

FIG. 17 illustrates an exemplary information-presentation-method selection screen for determining the information to be presented at step S1603. For example, the information-presentation-method selection screen 1700 includes alternatives for enriching the comprehension of the user, such as a radio button 1701 for presenting the text of the content, a radio button 1702 for reducing the sound reproducing rate of the content, and a radio button 1703 for presenting the answer.

For example, the information control unit 114 outputs the information-presentation-method selection screen 1700 to the touch panel 103 in a case where the acquired comprehension level is a predetermined value or less (e.g., 50% or less). The information control unit 114 presents information selected by the user through the information-presentation-method selection screen 1700. As described above, the dialogue system 101 according to the present embodiment can present a content depending on the comprehension level of the user.

The memory 106 may include a sound recognition unit that is a program for performing language recognition with sound. For example, the sound recognition unit converts an input in sound language received from the user, into text and then transmits the text to an information presentation unit 110 and the information control unit 114. This arrangement enables the dialogue system 101 to dialogue with a human with the sound language.

### Third Embodiment

Although the biological-information measurement instrument 104 measures a brain function with the near-infrared spectrophotometry in the first and second embodiments, a biological-information measurement instrument 104 according to the present embodiment may measure brain waves or may measure a brain function with, for example, functional magnetic resonance imaging.

The biological-information measurement instrument 104 may further include an eye-tracking instrument or a camera, and may further observe the visual line or the expression of a user. In this case, a biological-information acquisition unit 111 further acquires time series of visual-line information or expression information acquired by the biological-information measurement instrument 104, and then adds the time series to channels. A dialogue device 102 can calculate a comprehension level with higher accuracy with the visual-line information or the expression information of the user.

Note that, the present invention is not limited to the embodiments, and thus includes various modifications. For example, the embodiments have been described in detail for easy understanding of the present invention, and thus the present invention is not necessarily limited to including all the described configurations. Part of the configuration in one embodiment can be replaced with the configuration in another embodiment, or the configuration in one embodiment and the configuration in another embodiment can be combined together. For part of the configuration in each embodiment, addition, removal, or replacement of another configuration may be made.

For each of the configurations, the functions, the processing units, and the processing means, part or all thereof may be achieved by hardware, for example, designed with an integrated circuit. For example, each of the configurations and the functions may be achieved by software in which a processor interprets and executes a program for achieving each function. Information, such as the program, a table, or a file for achieving each function, can be stored in a recording device, such as a memory, a hard disk, or a solid state drive (SSD), or a recording medium, such as an IC card, an SD card, or a DVD.

Control lines and information lines considered necessary for the descriptions, have been illustrated, and thus all control lines and information lines have not necessarily been illustrated for the product. In practice, it may be considered that almost all the configurations are mutually connected.

1. A comprehension-level calculation device configured to calculate a comprehension level of a user to sound language, includes: a processor; and a storage device, in which the storage device retains respective time series of pieces of biological information in a plurality of regions of the user during presentation of the sound language to the user, and the processor: calculates a time-series similarity level for each pair of the time series; calculates the comprehension level, based on the calculated similarity level; and determines, in a case where the calculated similarity level is higher, the comprehension level as a higher value in the calculation of the comprehension level.

2. The comprehension-level calculation device according to claim 1, wherein the processor:
calculates, for each piece of biological information in the plurality of regions, an average value of the similarity levels corresponding to the pairs including the time series of the piece of biological information;
calculates a weighting sum of the calculated average value with a previously determined weight for each piece of biological information in the plurality of regions; and
calculates the comprehension level, based on the calculated weighting sum.

3. The comprehension-level calculation device according to claim 1, wherein the processor:
specifies, for each piece of biological information in the plurality of regions, the number of similarity levels having a predetermined value or more from the similarity levels corresponding to the pairs including the time series of the piece of biological information;
calculates a weighting sum of the specified number with a previously determined weight for each piece of biological information in the plurality of regions; and
calculates the comprehension level, based on the calculated weighting sum.

4. The comprehension-level calculation device according to claim 1, wherein the processor:
generates a graph in which, with the pieces of biological information in the plurality of regions each expressed with a node, nodes corresponding to a pair of time series in which the calculated similarity level is a predetermined value or more are connected through an edge, with a force-directed algorithm; and
calculates the comprehension level, based on a weighting sum with a predetermined weight of a distance between the nodes in the generated graph.

5. The comprehension-level calculation device according to claim 4, further comprising: a display device,
wherein the processor outputs the generated graph to the display device.

6. The comprehension-level calculation device according to claim 1, further comprising: a display device,
wherein the processor:
creates a heat map corresponding to a correlation matrix including the calculated similarity level as an element; and
outputs the created heat map to the display device.

7. The comprehension-level calculation device according to claim 1, further comprising: a display device,
wherein the processor:
acquires, for each of a plurality of criterial times, the respective time series during a predetermined period including the criterial time, from the time series of the pieces of biological information in the plurality of regions;
calculates the time-series similarity level for each pair of the acquired time series;
creates a heat map corresponding to a correlation matrix including the calculated similarity level as an element; and
outputs the heat map corresponding to each of the plurality of criterial times, to the display device.

8. The comprehension-level calculation device according to claim 1, wherein the processor:
acquires, for each of a plurality of criterial times, the respective time series during a predetermined period including the criterial time, from the plurality of time series;
calculates the time-series similarity level for each pair of the acquired time series; and
calculates the comprehension level, based on a time-series transition of the calculated similarity level.

9. The comprehension-level calculation device according to claim 8, wherein the plurality of regions includes auditory cortex, a first region in a right brain, and a second region in the right brain, and
the processor increases the comprehension level in accordance with a predetermined condition in a case where determining:
that the similarity level corresponding to a pair including a time series of biological information in the auditory cortex, at a first time included in the plurality of criterial times, is higher than the predetermined condition;
that the similarity level between a time series of first biological information in the first region and a time series of second biological information in the second region at the first time, is lower than the predetermined condition; and
that the similarity level between the time series of the first biological information and the time series of the second biological information at a second time after the first time included in the plurality of criterial times, is higher than the predetermined condition.

10. The comprehension-level calculation device according to claim 1, wherein the plurality of regions includes at least one of a combination of a first region in a left brain and a second region in the left brain, a combination of a third region in a right brain and a fourth region in the right brain, a combination of a fifth region in the left brain and a sixth region in the right brain, a combination of auditory cortex and Broca' s area, and a combination of the auditory cortex and Wernicke's area, and
the processor increases the comprehension level in accordance with a predetermined condition in a case where determining that the similarity level of the biological information corresponding to the at least one is higher than the predetermined condition.

11. The comprehension-level calculation device according to claim 1, wherein the time series retained by the storage device include the respective time series of the pieces of biological information in the plurality of regions of the user during the presentation of at least one of a text having a content identical to a content of the sound language and an image indicating the content of the sound language, and the sound language, to the user.

12. The comprehension-level calculation device according to claim 1, further comprising: an output device,
wherein the storage device retains content that enriches comprehension of the sound language, and
the processor outputs the content to the output device in a case where determining that the calculated comprehension level is a predetermined value or less.

13. The comprehension-level calculation device according to claim 1, wherein the pieces of biological information in the plurality of regions each include at least one of visual-line information and expression information.

14. A method of calculating a comprehension level of a user to sound language with a comprehension-level calculation device, the comprehension-level calculation device being configured to retain respective time series of pieces of biological information in a plurality of regions of the user during presentation of the sound language to the user, the method comprising:
by the comprehension-level calculation device,
calculating a time-series similarity level for each pair of the time series;
calculating the comprehension level, based on the calculated similarity level; and
determining, in a case where the calculated similarity level is higher, the comprehension level as a higher value in the calculation of the comprehension level.
